(19) United States
(12) Patent Application Publication
(10) Pub. No.: US 2017/0253281 A1
(43) Pub. Date: Sep. 7, 2017

(54) POP-UP STRUCTURE OF TAIL GATE

(71) Applicants: Hyundai Motor Company, Seoul (KR); Kia Motors Corporation, Seoul (KR)

(72) Inventors: Sang Moon KWAK, Hwaseong-si (KR); Seung Yeol RYU, Seoul (KR); Jungmin EOM, lncheon (KR)

(73) Assignees: Hyundai Motor Company, Seoul (KR); Kia Motors Corporation, Seoul (KR)

(21) Appl. No.: 15/248,747

(22) Filed: Aug. 26, 2016

(30) Foreign Application Priority Data
Mar. 2, 2016 (KR) 10-2016-0025322

(51) Int. Cl. B62D 33/037; E05B 81/04; E05B 85/04; E05C 3/12

(52) U.S. Cl. CPC B62D 33/037; E05C 3/124; E05B 81/04; E05B 85/04

(57) ABSTRACT

A pop-up structure of a tail gate may include a striker disposed at a side of an opening of a vehicle, a gate to selectively open and close the opening and including a bracket attached thereon, a latch plate rotatably disposed about a latch pin positioned on the bracket, the latch plate including a latch groove into which the striker is locked, and having a locking bump formed on an outer surface of the latch plate, a stopper lever rotatably disposed about a stopper pin positioned on the bracket, and including a stopper locked to the locking bump to stop rotation of the latch plate, a pop-up lever rotatably disposed about a lever pin positioned on the bracket, and including an outer end which is extended to a side and pushes the striker, and a pop-up spring elastically supporting the pop-up lever to rotate about the lever pin.

### CROSS-REFERENCE TO RELATED APPLICATION

The present application claims priority to Korean Patent Application No. 10-2016-0025322, filed Mar. 2, 2016, the entire contents of which is incorporated herein for all purposes by this reference.

### BACKGROUND OF THE INVENTION

Field of the Invention

The present invention relates to a pop-up structure of a tail gate, which lifts a tail gate to a preset level in a state where a locking state of the tail gate disposed at an opening of a vehicle is released, thereby improving a user's convenience.

Description of Related Art

Currently, a locking structure of a tail gate in a general vehicle is implemented through an assembling structure between a striker installed on a vehicle body and a latch plate installed at the tail gate. As the latch plate is rotated, the striker and the latch plate are locked to each other or separated from each other.

A user presses a switch to open the tail gate, and the switch rotates the latch plate to release the locking state between the tail gate and the latch plate. Then, the tail gate is opened in the vehicle.

Although the locking state between the latch plate and the striker is released through the rotation of the latch plate, the user must lift the tail gate from the vehicle body using a relatively large strength, because the tail gate is pressed against the vehicle body through a weather strip.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a pop-up structure of a tail gate, which has advantages of lifting a tail gate to a preset level through a pop-up lever installed in a locking device when a locking structure between a striker and a latch plate is released, thereby improving a user's convenience and reducing an amount of strength required for lifting the tail gate.

According to various aspects of the present invention, a pop-up structure of a tail gate may include a striker disposed at one side of an opening of a vehicle, a gate to selectively open and close the opening and including a bracket attached thereon at a position to correspond to a position of the striker, a latch plate rotatably disposed about a latch pin positioned on the bracket, the latch plate including a latch groove into which the striker is locked, and having a locking bump formed on an outer surface of the latch plate, a stopper lever rotatably disposed about a stopper pin positioned on the bracket, and including a stopper locked to the locking bump to stop rotation of the latch plate, a pop-up lever rotatably disposed about a lever pin positioned on the bracket, and including an outer end which is extended to one side and pushes the striker, and a pop-up spring elastically supporting the pop-up lever to rotate about the lever pin, such that the outer end of the pop-up lever pushes the striker.

The pop-up lever may include a first member extended to a first side from the lever pin to push the striker outward, and a second member extended to a second side from the lever pin, including a spring hook which is elastically supported by the pop-up spring, and integrated with the first member at a preset angle provided therebetween.

The pop-up structure may further include a latch spring elastically supporting the latch plate to rotate in a first direction about the latch pin.

The stopper of the stopper lever may be supported by the locking bump to restrict the latch plate from rotating in the first direction.

While the rotation of the latch plate in the one direction is stopped by the stopper of the stopper lever, the latch groove may be disposed in an opposite direction to a separation direction of the striker, such that a leading end of the striker is locked to the latch groove of the latch plate, and one end of the first member of the pop-up lever may elastically support a hook portion of the striker in the separation direction.

The pop-up spring may be mounted on the bracket through a spring pin disposed on the bracket.

The pop-up spring may elastically support an end of the second member of the pop-up lever such that the pop-up lever is rotated in a second direction about the lever pin.

The pop-up structure may further include a driver to push or pull one side of the stopper lever such that the stopper of the stopper lever is separated from the locking bump, and a switch to operate the driver according to an operation signal.

According to various aspects of the present invention, a pop-up structure of a tail gate may include a striker disposed at one side of an opening of a vehicle body, a bracket fixed to a tail gate which is disposed to selectively open and close the opening, and having an entry groove formed at one side of the bracket such that the striker is introduced into the entry groove, a latch plate rotatably disposed on the bracket through a latch pin positioned at one side of the entry groove, having a latch groove formed at one side of the latch plate such that the striker is inserted into the latch groove, and having a locking bump formed at another side of the latch plate, a latch spring rotating the latch plate in one direction such that the latch groove is disposed in a direction where the striker is separated, a stopper lever rotatably disposed on the bracket through a lever pin disposed at another side of the entry groove, and supporting the locking bump to stop the rotation of the latch plate in a first direction, a pop-up lever disposed to rotate about the lever pin, while pushing the striker to an outside of the entry groove, and a pop-up spring elastically supporting a side of the pop-up lever to rotate the pop-up lever in a second direction.

The pop-up lever may include a first member extended to one side from the lever pin so as to push the striker to the outside of the entry groove, and a second member extended to another side from the lever pin, having a spring hook which is elastically supported by the pop-up spring, and integrated with the first member at a preset angle provided therebetween.

According to various embodiments of the present invention, when the locking structure between the striker and the latch plate is released, the pop-up lever installed in the locking device may lift the tail gate to a preset level, thereby improving a user's convenience and reducing an amount of strength required for lifting the tail gate.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic side view illustrating a locking device of a tail gate according to various embodiments of the present invention.

FIG. 2 is an internal side view illustrating a locking state in a pop-up structure of the tail gate according to various embodiments of the present invention.

FIG. 3 is an internal side view illustrating an unlocking state in the pop-up structure of the tail gate according to various embodiments of the present invention.

FIG. 4 is a perspective view illustrating the pop-up structure of the tail gate according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the present invention, a locking structure and a pop-up structure are applied to a tail gate. However, the locking structure and the pop-up structure may be selectively applied to a gate which includes a door or hood of a vehicle and opens/closes an opening such as a trunk of the vehicle.

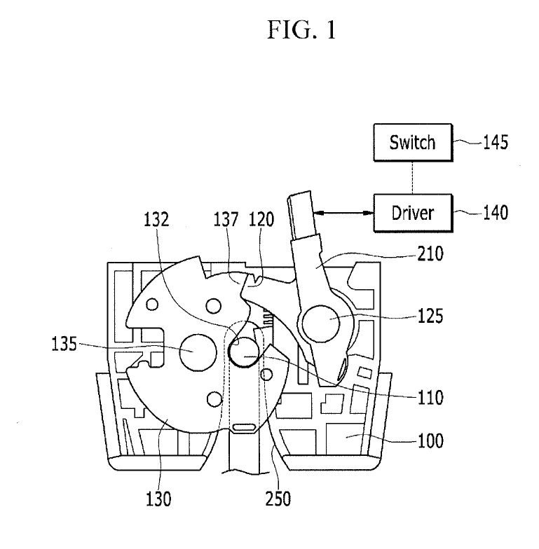

FIG. 1 is a schematic side view illustrating a locking device of a tail gate according to various embodiments of the present invention.

Referring to FIG. 1, the locking device of the tail gate includes a bracket 100, an entry groove 250, a striker 110, a stopper pin 125, a stopper lever 210, a driver 140, a switch 145, a locking bump 137, a latch groove 132, a latch pin 135 and a latch plate 130.

The tail gate is disposed to open/close an opening such as a rear trunk of the vehicle, the bracket 100 is mounted at the bottom of the tail gate, and the bracket 100 has the entry groove 250 formed from bottom to top. As the bracket 100 is lowered, the striker 110 is moved along the entry groove 250 from bottom to top.

As illustrated in FIG. 1, the locking device includes the latch pin 135, the latch plate 130, the striker 110, the stopper lever 210, the driver 140 and the switch 145.

The latch plate 130 is rotatably disposed at one side of the bracket 100 through the latch pin 135, the latch groove 132 is formed at one side of the latch plate 130, and the locking bump 137 is formed at the other side of the latch plate 130.

According to the rotational position of the latch plate 130, the striker 110 can be inserted into the latch groove 132. The striker 110 may be inserted into the latch groove 132.

The stopper lever 210 is rotatably disposed at the other side of the bracket 100 through the stopper pin 125, and the stopper 120 formed at one side of the stopper lever 210 supports the locking bump 137 and prevents the rotation of the latch plate 130 in the clockwise direction.

Furthermore, a latch spring which elastically supports the latch plate 130 is disposed to rotate the latch plate 130 in the clockwise direction.

The driver 140 is disposed to pull or push an outer end of the stopper lever 210. When the driver 140 pulls one end of the stopper lever 210, the stopper 120 is separated from the locking bump 137, and the latch plate 130 is rotated in the clockwise direction by the latch spring. The switch 145 may apply an operation signal to control the operation of the driver 140.

According to various embodiments of the present invention, the driver 140 and the switch 145 may not be installed, but the user may manually operate the stopper lever 210.

When the latch plate 130 is rotated in the counterclockwise direction such that the latch groove 132 faces upward in a state where the striker 110 is introduced into the entry groove 250 and inserted into the latch groove 132, the striker 110 is locked while the downward movement of the striker 110 is prevented as the striker is fixed in position.

When the latch plate 130 is rotated in the clockwise direction such that the latch groove 132 faces downward, the striker 110 is separated downward from the latch groove 132, and the tail gate is opened while the bracket 100 is lifted with the tail gate.

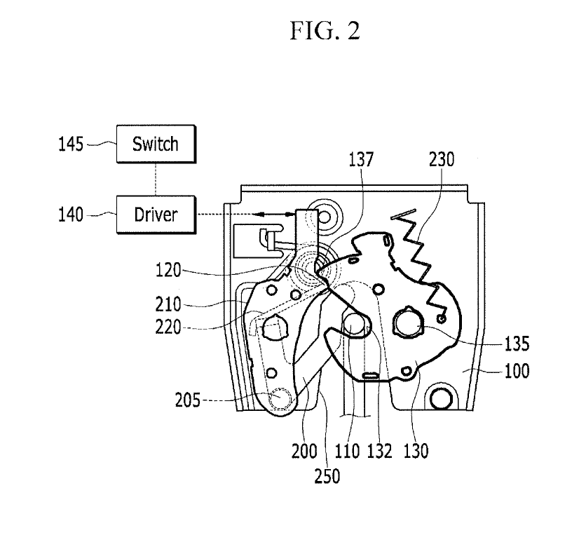

FIG. 2 is an internal side view illustrating a locking state in a pop-up structure of the tail gate according to various embodiments of the present invention.

The structure of FIG. 2 may have the same or similar parts as those of FIG. 1, or include different components from those of FIG. 1. Alternatively, the components of FIG. 1 and FIG. 2 may be selected to embody the technical idea of the present invention.

Referring to FIG. 2, the pop-up structure of the tail gate includes a bracket 100, a latch pin 135, a latch spring 230, a locking bump 137, a switch 145, a driver 140, a stopper lever 210, a pop-up spring 220, a pop-up lever 200, a lever pin 205, a stopper 120, a striker 110, a latch groove 132 and a latch plate 130.

The pop-up structure has a striker entry groove 250 formed upward from the bottom of the bracket 100 by a predetermined distance, and the striker 110 is introduced into the striker entry groove 250 along the upward direction.

The latch pin 135 is disposed at the right of the striker entry groove 250, and the latch plate 130 is mounted on the bracket 100 so as to rotate about the latch pin 135.

The locking bump 137 is formed at one side of the latch plate 130, and the latch spring 230 elastically supports the latch plate 130 such that the latch plate 130 is rotated in the counterclockwise direction.

The lever pin 205 is disposed at the left bottom of the striker entry groove 250, and the pop-up lever 200 and the stopper lever 210 are mounted on the bracket 100 so as to rotate about the lever pin 205.

The stopper lever 210 is extended upward from the lever pin 205, the upper end of the stopper lever 210 is pulled or pushed by the driver 140, and the stopper 120 is formed at one side of the stopper lever 210.

The stopper 120 of the stopper lever 210 supports the locking bump 137 of the latch plate 130, and prevents the rotation of the latch plate 130 in the counterclockwise direction.

The pop-up spring 220 elastically supports one end of the pop-up lever 200 such that the pop-up lever 200 is rotated in the clockwise direction.

Thus, in a state where the latch groove 132 faces upward and the striker 110 is fastened to the latch groove 132, the other end of the pop-up lever 200 pushes the striker 110 in the separation direction of the striker 110 (downward direction).

In various embodiments of the present invention, the switch 145 may apply an operation signal to control the operation of the driver 140. In various embodiments, the driver 140 and the switch 145 are not installed, but the user instead manually operates the stopper lever 210.

Furthermore, when the latch groove 132 of the latch plate 130 faces upward in a state where the striker 110 is inserted into the latch groove 132, the locking state is maintained, and the striker 110 is locked and fixed in the latch groove 132.

Then, when the latch groove 132 faces downward, the striker 110 is separated downward from the latch groove 132, and the tail gate is opened while the bracket 100 is lifted with the tail gate.

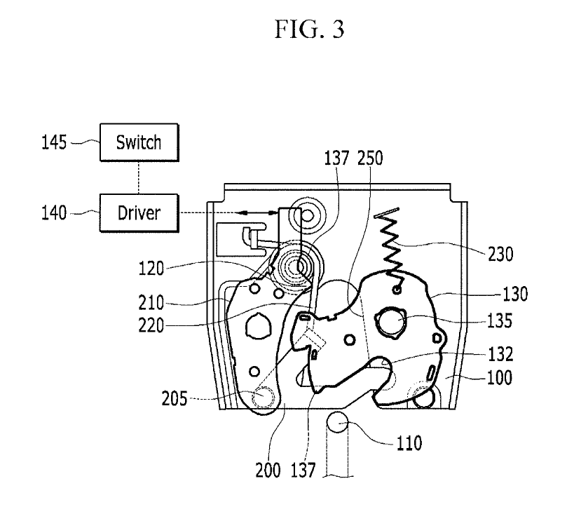

FIG. 3 is an internal side view illustrating an unlocking state in the pop-up structure of the tail gate according to various embodiments of the present invention.

Referring to FIG. 3, when the upper end of the stopper lever 210 is pulled by the driver 140 or the user, the stopper 120 and the locking bump 137 are separated from each other, and the latch plate 130 is rotated in the counterclockwise direction by the latch spring 230.

The latch groove 132 faces the downward direction corresponding to the separation direction of the striker 110, and the striker 110 is separated from the latch plate 130.

Moreover, the pop-up lever 200 pushes the striker 110 downward through the spring force of the pop-up spring 220, and the bracket 100 is lifted to pop up the tail gate to a preset level.

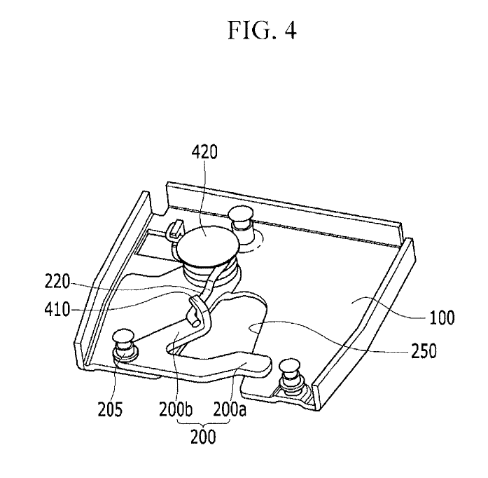

FIG. 4 is a perspective view illustrating the pop-up structure of the tail gate according to various embodiments of the present invention. The detailed descriptions of the same or similar components as or to those of FIGS. 1 to 3 will be omitted, and characteristic differences therebetween will be described in detail.

Referring to FIG. 4, the pop-up lever 200 includes first and second members 200a and 200b, the first member 200a is extended to one side from the lever pin 205, and the second member 200b is integrated with the first member 200a and extended to the other side at a preset angle set between the first and second members 200a and 200b.

The pop-up spring 220 is fixed to the bracket 100 through the spring pin 420, one end of the pop-up spring 220 is fixed to the bracket 100, and the other end of the pop-up spring 220 elastically supports a spring hook 410 formed at an end of the second member 200b in the clockwise direction (refer to FIG. 3), such that the pop-up lever 200 is rotated in the clockwise direction about the lever pin 205.

Thus, in a state where the latch groove 132 of the latch plate 130 and the striker 110 are separated from each other, the first member 200a elastically supports the striker 110 in the outward direction (downward direction in FIG. 3), and the tail gate is lifted to the preset level.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pop-up structure of a tail gate, comprising:
a striker disposed at a side of an opening of a vehicle;
the gate to selectively open and close the opening and including a bracket attached thereon at a position to correspond to a position of the striker;
a latch plate rotatably disposed about a latch pin positioned on the bracket, the latch plate including a latch groove into which the striker is selectively locked, and having a locking bump formed on an outer surface of the latch plate;
a stopper lever rotatably disposed about a stopper pin positioned on the bracket, and including a stopper selectively locked to the locking bump to stop rotation of the latch plate;
a pop-up lever rotatably disposed about a lever pin positioned on the bracket, and including an outer end extended to a side and pushing the striker; and
a pop-up spring elastically supporting the pop-up lever to rotate about the lever pin, such that the outer end of the pop-up lever pushes the striker.

2. The pop-up structure of claim 1, wherein the pop-up lever comprises:
a first member extended to a first side from the lever pin to push the striker outward; and
a second member extended to a second side from the lever pin, including a spring hook elastically supported by the pop-up spring and integrated with the first member at a preset angle provided therebetween.

3. The pop-up structure of claim 2, further comprising a latch spring elastically supporting the latch plate to rotate in a first direction about the latch pin.

4. The pop-up structure of claim 3, wherein the stopper of the stopper lever is supported by the locking bump to restrict the latch plate from rotating in the first direction.

5. The pop-up structure of claim 4, wherein while the rotation of the latch plate in the first direction is stopped by the stopper of the stopper lever,
the latch groove is disposed in an opposite direction to a separation direction of the striker, such that a leading end of the striker is locked to the latch groove of the latch plate, and
a first end of the first member of the pop-up lever elastically supports a hook portion of the striker in the separation direction.

6. The pop-up structure of claim 4, wherein the pop-up spring is mounted on the bracket through a spring pin disposed on the bracket.

7. The pop-up structure of claim 4, wherein the pop-up spring elastically supports an end of the second member of the pop-up lever such that the pop-up lever is rotated in a second direction about the lever pin.

8. The pop-up structure of claim 4, further comprising:
a driver to push or pull a side of the stopper lever such that the stopper of the stopper lever is separated from the locking bump; and
a switch to operate the driver according to an operation signal.

9. A pop-up structure of a tail gate, comprising:
a striker disposed at a side of an opening of a vehicle body;
a bracket fixed to the tail gate disposed to selectively open and close the opening, and having an entry groove formed at a side of the bracket such that the striker is introduced into the entry groove;
a latch plate rotatably disposed on the bracket through a latch pin positioned at a side of the entry groove, having a latch groove formed at a first side of the latch plate such that the striker is inserted into the latch groove, and having a locking bump formed at a second side of the latch plate;
a latch spring rotating the latch plate in one direction such that the latch groove is disposed in a direction where the striker is separated;
a stopper lever rotatably disposed on the bracket through a lever pin disposed at a side of the entry groove, and supporting the locking bump to stop the rotation of the latch plate in a first direction;
a pop-up lever disposed to rotate about the lever pin, while pushing the striker to an outside of the entry groove; and
a pop-up spring elastically supporting a side of the pop-up lever to rotate the pop-up lever in a second direction.

10. The pop-up structure of claim 9, further comprising:
a driver pushing or pulling a side of the stopper lever such that a stopper of the stopper lever is separated from the locking bump; and
a switch operating the driver according to an operation signal.

11. The pop-up structure of claim 9, wherein the pop-up lever comprises:
a first member extended to a side from the lever pin to push the striker to the outside of the entry groove; and
a second member extended to a second side from the lever pin, having a spring hook elastically supported by the pop-up spring and integrated with the first member at a preset angle provided therebetween.
